(19) United States
(12) Patent Application Publication
(10) Pub. No.: US 2018/0078912 A1
(43) Pub. Date: Mar. 22, 2018

(54) LOW PRESSURE DROP SWIRLING FLOW MIXER

(71) Applicant: GM Global Technology Operations LLC, Detroit, MI (US)

(72) Inventors: Anil YADAV, Bangalore (IN); Jianwen LI, Farmington Hills, MI (US); Calvin K. KOCH, Bloomfield Hills, MI (US); Rahul MITAL, Rochester Hills, MI (US)

(21) Appl. No.: 15/267,287

(22) Filed: Sep. 16, 2016

(51) Int. Cl. B01F 7/00; B01F 3/04; F01N 3/28

(52) U.S. Cl. CPC B01F 7/00425; B01F 7/00633; B01D 53/9418; F01N 3/2892; B01F 3/04028

(57) ABSTRACT

An assembly for mixing liquid within a gas flow includes a hollow conduit that is configured for containing a flow of gas and liquid droplets. The assembly includes a hollow conduit having an inner wall and configured for containing a flow of gas and liquid droplets. A first plurality of spaced blades is disposed in the conduit in a first plane. A second plurality of spaced blades are disposed in the conduit in a second plane disposed downstream of the first plane, the second plurality of spaced blades being circumferentially offset from the first plurality of spaced blades. A third plurality of spaced blades are disposed in the conduit in a third plane disposed downstream of the second plane, the third plurality of spaced blades being circumferentially offset from the second plurality of spaced blades.

### FIELD

The present disclosure relates to an assembly for mixing liquid within a gas flow, such as for a vehicle exhaust treatment system or a fuel intake system.

### BACKGROUND

This section provides background information related to the present disclosure which is not necessarily prior art.

Certain vehicle systems include the transport of liquid droplets within a flow of gas, such as in a vehicle exhaust treatment system or an engine fuel intake system. Controlled dispersion of the liquid droplets within the flow may be advantageous for several reasons. For example, in one type of vehicle exhaust system, liquid hydrocarbons (HC) are injected within a gas flow to a diesel oxidation catalyst (DOC) that is upstream of a diesel particulate filter (DPF). The hydrocarbon is oxidized in the DOC in an exothermic reaction, creating the high temperatures necessary in the downstream DPF for burning diesel particulate, thus burning off the particulate to regenerate the DPF and reduce system backpressure. In another example, a diesel exhaust fluid, such as urea or another reductant of oxides of nitrogen (NOₓ), is injected upstream of a catalyst, such as a selective catalyst reduction (SCR) catalyst, where it is converted to ammonia that is used to reduce NOₓ to nitrogen (N₂). In another example, hydrocarbons are periodically injected into the exhaust flow upstream of a lean NOₓ trap to regenerate the trap. In an engine fuel intake system as well, liquid fuel is entrained in air flow for combustion in the engine cylinders.

### SUMMARY

This section provides a general summary of the disclosure, and is not a comprehensive disclosure of its full scope or all of its features.

An improved mixture assembly achieves a desired disbursement of liquid droplets downstream of the mixer assembly, thus improving operation of a vehicle component that processes the droplets, such as a diesel oxidation catalyst (DOC) and a selective catalyst reduction (SCR) catalyst, or a lean NOₓ trap.

An assembly for mixing liquid within a flow of gas includes a hollow conduit that has an inner wall and is configured for containing a flow of gas with liquid droplets. The assembly also includes multiple spaced blades disposed in multiple spaced planes within the conduit. Each of the blades is operatively connected to the inner wall of the conduit. The blades direct the liquid droplets to create a preferred distribution of the liquid droplets within the gas flow. For example, the blades may create a substantially uniform distribution of the liquid droplets in the downstream gas flow. When the assembly is used upstream of a DOC and a DPF, a radial temperature differential in the DPF may be reduced, thus potentially improving regeneration efficiency. When the assembly is used upstream of an SCR catalyst or a lean NOₓ trap, the ability to reduce NOₓ may be improved. Likewise, if the mixer assembly is used upstream of engine fuel intake, improved mixing of fuel and air may improve engine combustion.

An assembly is provided for mixing liquid within a gas flow includes a hollow conduit that is configured for containing a flow of gas and liquid droplets. The assembly includes a hollow conduit having an inner wall and configured for containing a flow of gas and liquid droplets. A first plurality of spaced blades is disposed in the conduit in a first plane. A second plurality of spaced blades is disposed in the conduit in a second plane disposed downstream of the first plane, the second plurality of spaced blades being circumferentially offset from the first plurality of spaced blades. A third plurality of spaced blades is disposed in the conduit in a third plane disposed downstream of the second plane, the third plurality of spaced blades being circumferentially offset from the second plurality of spaced blades.

The above features and advantages and other features and advantages of the claimed invention are readily apparent from the following detailed description of the best modes for carrying out the claimed invention when taken in connection with the accompanying drawings.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic illustration of a portion of a vehicle showing exhaust gas flow through an exhaust system;

FIG. 2 is a perspective view of a mixer assembly of the exhaust system according to the principles of the present disclosure;

FIG. 3 is a plan view of the mixer assembly of FIG. 2 with the blades in different planes being circumferentially offset at a first spacing;

FIG. 4 is a plan view of the mixer assembly of FIG. 2 with the blades in different planes being circumferentially offset at a second spacing;

FIG. 5 is a plan view of the mixer assembly of FIG. 2 with the blades in different planes being circumferentially offset at a third spacing;

FIG. 6 is a perspective view illustrating an alternative manufacturing method for a mixer assembly according to the principles of the present disclosure;

FIG. 7 is a perspective view illustrating an alternative manufacturing method for a mixer assembly according to the principles of the present disclosure.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

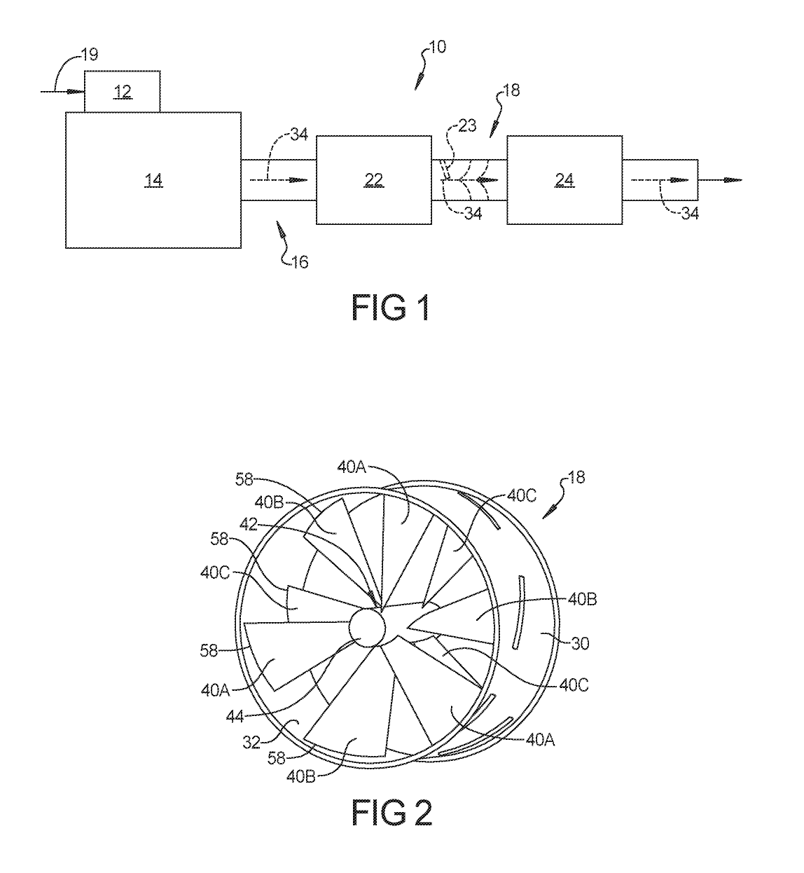

Referring to the drawings, wherein like reference numbers refer to like components throughout the several views, FIG. 1 shows a portion of a vehicle 10 having an air and fuel intake system 12 for an engine 14 and an exhaust system 16. A mixer assembly 18 is included for improving mixing of liquid within exhaust flow as explained herein. The mixer assembly 18 is shown in greater detail in FIG. 2. The specific benefits of the structure of the mixer assembly 18 are discussed herein. Although shown in the exhaust system 16, the mixer assembly 18 may also be used in the engine air and fuel intake system 12 to affect the mixing of injected liquid fuel in the air flow 19 to improve combustion within cylinders of the engine 14.

The exhaust system 16 includes a diesel oxidation catalyst (DOC) 22, located upstream of the mixer assembly 18 in the flow of exhaust gas. A liquid injector 23, such as for injecting urea, is located upstream of the mixer assembly 18. A component 24 such as a selective catalyst reduction (SCR) catalyst is located downstream of the DOC 22 and downstream of the injector 23. Alternatively, the component 24 may be a lean NOₓ trap and the injector 23 may be a fuel injector to inject hydrocarbons to regenerate the lean NOₓ trap. Furthermore, component 24 may be either a diesel oxidation catalyst or a diesel particulate filter or a combined diesel oxidation catalyst and diesel particulate filter converter where the injector 23 may be a fuel injector to inject hydrocarbons that are oxidized in 24 to create exothermic heat to regenerate a downstream diesel particulate filter. The component 24 converts at least some of the oxides of nitrogen (NOₓ) in the exhaust flow into nitrogen and water. The mixer assembly 18 is configured to create a preferred distribution of liquid droplets (urea) in the gas flow to the component 24. The preferred distribution for an SCR trap may be a uniform distribution across the conduit 30 in the gas flow. In still other embodiments where the component 24 is an SCR catalyst, the exhaust system 16 could have a DOC 22 and a diesel particulate filter (DPF) but no SCR catalyst.

Referring to FIG. 2, the mixer assembly 18 is shown in greater detail. The mixer assembly 18 includes a conduit 30, which is an exhaust pipe or is inserted in line with an exhaust pipe on the vehicle 10. The conduit 30 has an inner wall 32 and encloses a flow of gas indicated by arrows 34 in FIG. 1 along with injected liquid droplets carried in the flow of gas 34.

The mixer assembly 18 includes multiple axially spaced hubs 38A-38C each with multiple spaced blades 40A-40C, respectively. In the embodiment of FIG. 2, the mixer assembly 18 has three axially spaced hubs 38A-38C in three separate planes and each with three circumferentially spaced blades 40A-40C. Flow from blades 40A in the first hub 38A fall on the blades 40B in the second hub 38B and then on the blades 40C in the third hub 38C. Gaps 44 between the blades allow some exhaust gas to escape thereby reducing pressure drop and better mixing. Injected liquid droplets impinge on all the blades of the mixer. Droplets impinging on blade 40A in the first hub 38A undergoes further impingement and breakup on blade 40B of hub 38B and again on blade 40C of hub 38C. Similarly droplets impinging directly on blade 40B in the second hub 38B undergoes further impingement and breakup on blade 40C of hub 38C. Droplets impinging directly on blade 40C of hub 38C encounter higher gas velocity due to swirling action created by blades 40A and 40C. This multiple impingement and interaction of droplets with gas with higher velocity increases droplet break-up, evaporation and mixing. Axial distance between the hubs provide enough gaps 44 between the blades and allow some exhaust gas to escape thereby reducing pressure drop. Exhaust gas escaped through gaps 44 mixes with the swirling flow created by blades, downstream of the mixer.

Each of the blades 40 can be connected to an optional support element 42 that can be generally centered in the conduit 30. Each of the blades 40A-40C is connected to the inner wall 32 of the conduit 30.

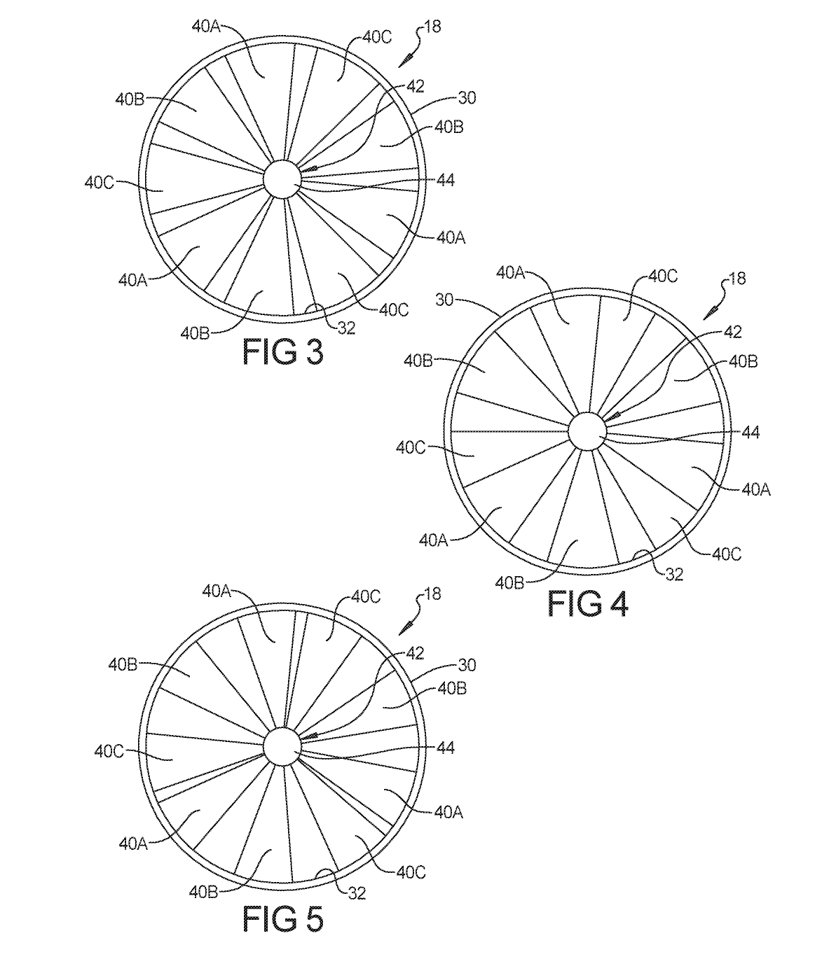

Each blade 40A-40C has a generally helical shape, so that it extends downstream in the conduit 30 in a spiral, with an outer edge 58 of each blade 40A-40C secured to the inner wall 32. The outer edge 58, therefore, has an arcuate shape so that it creates a spiraling pattern at the interface of the edge 58 and the inner wall 32. The blade size can be varied so that each blade has a width such as shown for example in FIG. 3 where each blade has a 30° width and they are separated with a 10° circumferential gap between the blades 40A, 40B; 40B, 40C; and 40C, 40A. other blade widths and other gaps can also be used such as for example as shown in FIG. 4, in which a 15° gap is shown between the blades 40A, 40B; and 40B, 40C, while the blade width is shown to be 30°. In this arrangement, the front edge of the blades 40A are aligned with the rearward edge of the blades 40C. In the embodiment of FIG. 5, the blades are shown with a smaller blade width of 24° and a gap of 21°. Accordingly, a 21° gap is provided between the blades 40A, 40B; 40B, 40C and a gap of 6° is provided between the blades 40C and 40A. It should be understood that other numbers of hubs including 2 or more hubs and other numbers of blades in the hubs including 2 or more blades can be used depending upon the desired application. By way of example, although three hubs are shown with three blades in each hub, two axially spaced hubs could be used with four blades in each hub. The number of blades, the size of the blades and the gap spacing can be designed to provide a desired mixing and back pressure. In addition, the axial spacing between the hubs can be varied to provide desired mixing and back pressure.

The conduit 30 can be provided with expansion joints in the form of circumferential slots or cutouts to allow for expansion and contraction of the conduit 30 under various forces. With the mixer design according to the present disclosure, the overall diesel exhaust fluid mixing performance is the same or better with the new mixer blade arrangement while substantially reducing the pressure drop across the mixer. In particular, an exemplary prior art mixing device resulted in NOₓ conversion efficiency at approximately between 85 and 97% for low, medium and high flow, while providing a large pressure drop of approximate 43 kPa. In contrast, the mixer 18 as shown in FIGS. 2 and 3 provides an NOx conversion efficiency of approximately between 90 and 98% for low, medium and high flow, while providing a considerable pressure drop reduction of 36 kPa. The mixer as shown in FIG. 4 provides an NOx conversion efficiency of approximately between 87 and 98% for low, medium and high flows while providing a considerable pressure drop of 35 kPa. Finally, the mixer shown in FIG. 5 provides an NOx conversion efficiency at approximately between 85 and 97% for low, medium and high flow rates, while providing a pressure drop reduction of 29 kPa. Accordingly, it is evident that the arrangement of blades according to the principles of present disclosure provides considerable pressure drop reduction while maintaining the same or better mixing performance.

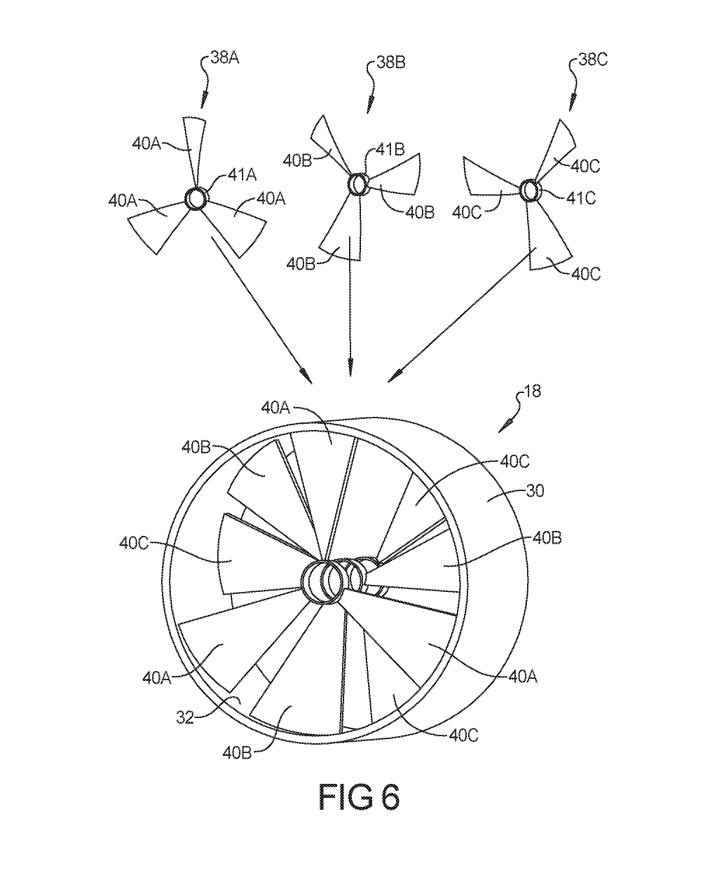

With reference to FIG. 2, the mixer 18 can be formed by welding the 9 blades 40A-40C to the conduit 30 and the impingement element 42. Alternatively, as shown in FIG. 6, each hub 38A-38C can be formed as a separate stamped 3-blade piece with the outer edges of each blade 40A-40C being welded to the conduit 30. Each stamped piece 38A-38C includes a center ring 41A-41C with the blades 40A-40C extending radially therefrom.

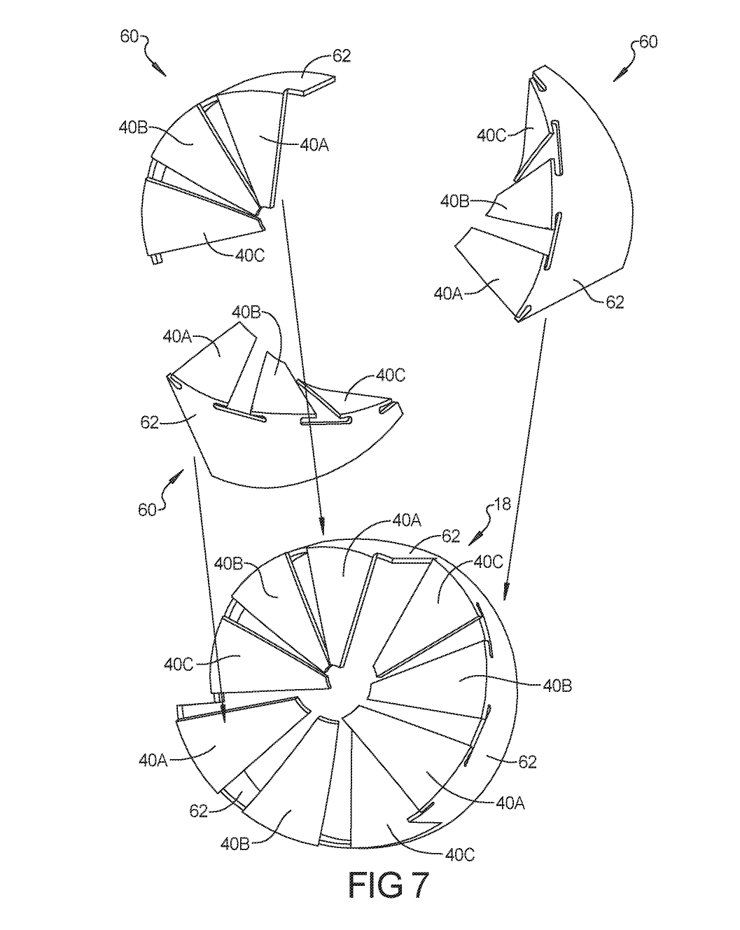

As a further alternative, the blades can be formed from a stamped piece as shown in FIG. 7. In particular, FIG. 7 shows 3 separate stamped pieces 60 each including a blade 40A, 40B, 40C from each hub. Each stamped piece 60 has a cylindrical wall segment 62 that forms a portion of the conduit 30, while each blade 40A, 40B, 40C extends from the cylindrical wall segment 62 as a bent piece. Each stamped piece 60 is assembled with the cylindrical wall segments 62 arranged in a complete cylinder to form the conduit 30 of the mixer 18 while the blades 40A, 40B, 40C are supported by the cylindrical wall segments 62.

In the embodiment of FIGS. 2-5, the support element 42 can have a generally cone-shaped surface 44 that faces the direction of the flow of gas 34 and tapers outward within the conduit 30 in a downstream direction; that is, the cone-shaped surface 44 points generally upstream.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A mixer assembly comprising:
a hollow conduit having an inner wall and configured for containing a flow of gas and liquid droplets;
a first plurality of spaced blades disposed in the conduit in a first plane;
a second plurality of spaced blades disposed in the conduit in a second plane disposed downstream of the first plane, the second plurality of spaced blades being circumferentially offset from the first plurality of spaced blades; and
a third plurality of spaced blades disposed in the conduit in a third plane disposed downstream of the second plane, the third plurality of spaced blades being circumferentially offset from the second plurality of spaced blades
wherein each of the first, second and third plurality of spaced blades are connected to the inner wall of the conduit.

2. The mixer assembly according to claim 1, wherein each of the first plurality of spaced blades has a generally helical shape.

3. The mixer assembly according to claim 2, wherein each of the second plurality of spaced blades has a generally helical shape.

4. The mixer assembly according to claim 3, wherein each of the third plurality of spaced blades has a generally helical shape.

5. The mixer assembly according to claim 1, wherein each of the first plurality of spaced blades, the second plurality of spaced blades and the third plurality of spaced blades are directly connected with a center element.

6. The mixer assembly according to claim 5, wherein each of the first plurality of spaced blades, the second plurality of spaced blades and the third plurality of spaced blades are directly connected with the center element by welding.

7. The mixer assembly according to claim 1, wherein each of the first plurality of spaced blades, the second plurality of spaced blades and the third plurality of spaced blades are directly connected with the conduit by welding.

8. The mixer assembly according to claim 1, wherein the inner wall of the conduit has a constant cylindrical shape.

9. The mixer assembly according to claim 1, wherein the second plurality of spaced blades are circumferentially offset from the first plurality of spaced blades by an angle of between 5 and 25 degrees.

10. The mixer assembly according to claim 1, wherein the second plurality of spaced blades are circumferentially offset from the third plurality of spaced blades by an angle of between 5 and 25 degrees.

11. A vehicle system comprising:
a hollow generally cylindrical conduit having an inner wall and configured for containing a flow of gas with liquid droplets;
a mixer assembly having:
a hollow conduit having an inner wall and configured for containing the flow of gas and liquid droplets;
a first plurality of spaced blades disposed in a first plane;
a second plurality of spaced blades disposed in a second plane disposed downstream of the first plane, the second plurality of spaced blades being circumferentially offset from the first plurality of spaced blades; and
a third plurality of spaced blades disposed in a third plane disposed downstream of the second plane, the third plurality of spaced blades being circumferentially offset from the second plurality of spaced blades
wherein each of the first, second and third plurality of spaced blades are connected to the inner wall of the conduit; and
a vehicle component operatively connected to the conduit downstream of the mixer assembly and operable to process the liquid droplets; wherein the mixer assembly is configured to create a desired disbursement of the liquid droplets in the flow of gas to the vehicle component.

12. The vehicle system according to claim 11, wherein each of the first plurality of spaced blades has a generally helical shape.

13. The vehicle system according to claim 12, wherein each of the second plurality of spaced blades has a generally helical shape.

14. The vehicle system according to claim 13, wherein each of the third plurality of spaced blades has a generally helical shape.

15. The vehicle system according to claim 11, wherein each of the first plurality of spaced blades, the second plurality of spaced blades and the third plurality of spaced blades are directly connected with the conduit by welding.

16. The vehicle system according to claim 11, wherein each of the first plurality of spaced blades, the second plurality of spaced blades and the third plurality of spaced blades are directly connected with a center element.

17. The vehicle system according to claim 11, wherein the inner wall of the conduit has a constant cylindrical shape.

18. The vehicle system according to claim 11, wherein the second plurality of spaced blades are circumferentially offset from the first plurality of spaced blades by an angle of between 5 and 25 degrees.

19. The assembly according to claim 17, wherein the second plurality of spaced blades are circumferentially offset from the third plurality of spaced blades by an angle of between 5 and 25 degrees.
